(19) United States
(12) Patent Application Publication
(10) Pub. No.: US 2025/0238698 A1
(43) Pub. Date: Jul. 24, 2025

(54) UPPER-BOUND EXECUTION TIME ESTIMATION OF CPU-BASED QUANTUM SIMULATIONS

(71) Applicant: Dell Products L.P., Round Rock, TX (US)

(72) Inventors: Rômulo Teixeira de Abreu Pinho, Niterói (BR); Alexander Eulalio Robles Robles, Valinhos (BR)

(21) Appl. No.: 18/420,624

(22) Filed: Jan. 23, 2024

(51) Int. Cl. G06N 10/20

(52) U.S. Cl. CPC G06N 10/20

(57) ABSTRACT

Techniques for generating prediction metrics for quantum circuits are disclosed. A GPU execution time for a quantum circuit is determined. A CPU execution time for the same quantum circuit is determined. A ratio factor between the CPU execution time and the GPU execution time is determined. For a new quantum circuit, an estimation is performed to estimate a new GPU execution time for the new quantum circuit. For the same new quantum circuit, a derivation is performed to derive a new CPU execution time by applying the ratio factor to the estimated new GPU execution time. Based at least on the estimated new GPU execution time and the new CPU execution time, either one of the GPU or the CPU is selected to execute the new quantum circuit.

### FIELD OF THE INVENTION

Embodiments of the present invention generally relate to predicting certain metrics for quantum algorithms. More particularly, at least some embodiments of the invention relate to systems, hardware, software, computer-readable media, and methods for making predictions to facilitate the proper selection of hardware used when executing a quantum circuit.

### BACKGROUND

Intelligent orchestration of hybrid classic-quantum workloads includes modelling the behavior of those workloads so that orchestration decisions can be made efficiently. In some cases, various predictions can be made to predict execution times and resource consumption for the hybrid quantum algorithms operating on quantum circuit simulation engines. These predictions are performed in an attempt to better select the hardware that will be used to execute the quantum circuits.

For any predictive analytics approach, collecting training data can often be a challenge. Acquiring the training data often involves executing a large collection of workloads on different platforms and collecting associated telemetry and service-level-objective metrics (SLOs), such as execution times. One particularly challenging scenario with regard to collecting the training data for predictive analysis relates to collecting execution times of large circuits (e.g., based on the number of qubits in those circuits) that take too long to be executed on the central processing unit (CPU) via simulation engines.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIGS. 1A and 1B illustrate an example architecture for predicting quantum circuit metrics.

FIG. 2 illustrates various metrics of interest.

FIG. 3 illustrates different jobs that may be performed by GPUs and CPUs.

FIG. 4 illustrates a data set of execution times.

FIG. 5 illustrates a comparison between CPU execution times and GPU execution times.

FIG. 6 illustrates a flowchart of an example method for predicting metrics for quantum circuit analysis.

FIG. 7 illustrates an example computer system that can be configured to perform any of the disclosed operations.

### DETAILED DESCRIPTION

The disclosed embodiments are beneficially structured to facilitate the collection of training data for predictive analysis, particularly as it relates to collecting execution times of large circuits that take longer to be executed on the CPU via simulation engines. At a high level, the disclosed embodiments generally leverage telemetry data from other sources, such as from workloads that are the same but that are executed on the GPU. From there, and with minimal data from workloads on the CPU, the embodiments can obtain upper-bound factors that enable the embodiments to estimate or predict execution times on the CPU for any hybrid classic-quantum workload. In this regard, the disclosed embodiments are beneficially directed to techniques involving a prediction mechanism that estimates execution metrics of quantum circuits on the CPU, which leverages telemetry data from the execution of circuits on the GPU.

The disclosed embodiments bring about numerous benefits, advantages, and practical applications to the field of predictive analysis. In particular, the disclosed embodiments beneficially address the prediction of quantum circuit execution times on the CPU with minimal training data. As another benefit, the embodiments find upper-bound circuit execution times on the CPU from the execution of similar circuits on the GPU. Accordingly, these and numerous other benefits will now be described in more detail throughout the remaining portions of this disclosure.

### Example Architectures

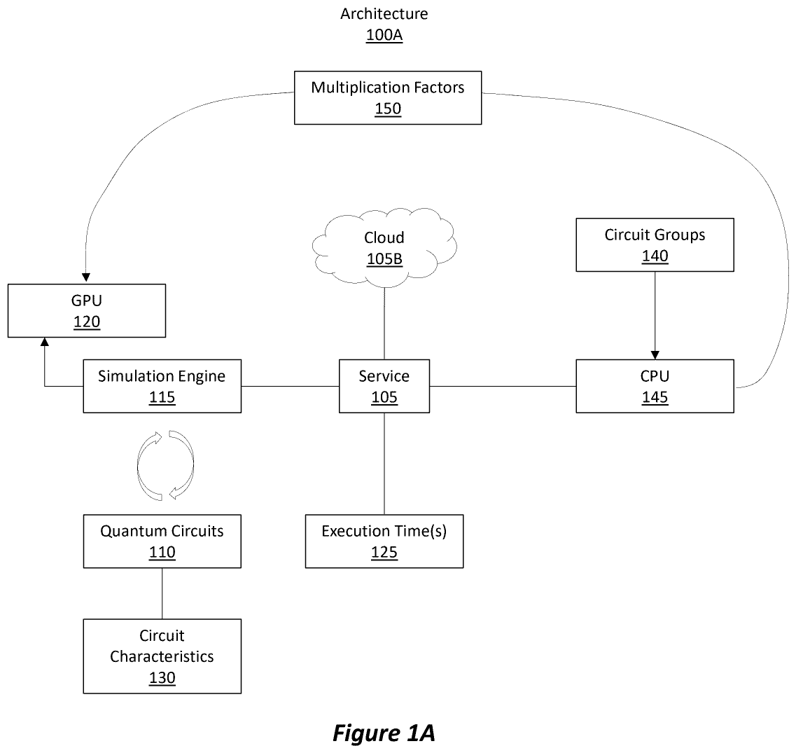

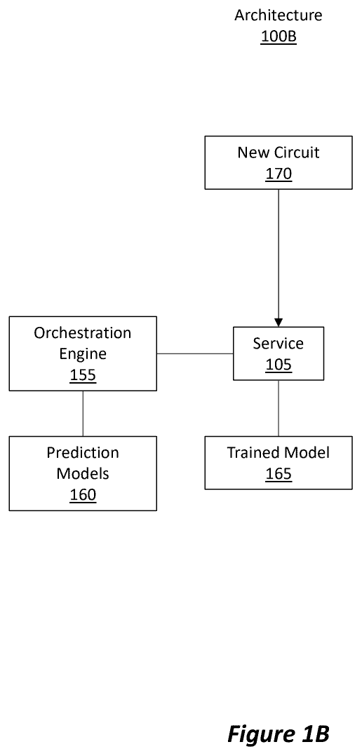

Attention will now be directed to FIG. 1A, which illustrates an example architecture 100A in which the disclosed principles may be employed. Architecture 100A shows a service 105.

As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine. The ML engine enables service 105 to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud environment 105B. In some implementations, service 105 is a local service operating on a local device. In some implementations, service 105 is a hybrid service that includes a cloud component operating in the cloud and a local component operating on a local device. These two components can communicate with one another.

Service 105 is generally tasked with facilitating the estimation of execution metrics for quantum circuits on the CPU by leveraging the telemetry data for the execution of circuits on the GPU. To do so, service 105 performs two steps, namely a training step (or set of steps) and an inference step (or set of steps).

The training step is illustrated in FIG. 1A and involves the service 105 executing a large collection (e.g., dozens, hundreds, or even thousands) of quantum circuits 110 on a simulation engine 115 that runs on the GPU 120. Service 105 collects the execution time for each of these executions (as shown by execution time(s) 125), and service 105 stores that information.

Service 105 then groups the circuits by circuit characteristics 130. One example of a circuit characteristic can be the number of qubits that each quantum algorithm has. Thus, multiple circuits may belong to the same group, and there may be multiple groups, as shown by circuit groups 140. Other characteristics can be used for the grouping process, and qubit number is just one example.

For each group of circuits in the circuit groups 140, service 105 finds (within each group) the circuit that took the longest time to run on the GPU, resulting in the identification of multiple circuits (one from each group in the circuit group 140). To be clear, a single circuit is selected from each group, and that selected circuit is the one that has the longest execution time. Service 105 then runs those identified circuits (i.e. one from each group) on the CPU 145.

Service 105 collects the execution time for each circuit's execution on the CPU. Typically, the CPU execution time will be longer than the GPU time, at least for larger circuits. Service 105 then stores this execution metric data.

For each of the circuits that were run on the CPU, service 105 computes a multiplication factor (aka a ratio factor), resulting in multiple multiplication factors 150 being computed and resulting in a multiplication factor being computed for each group of circuits in the circuit group 140. Notably, each multiplication factor is designed so that when used, each multiplication factor equates the execution time on the GPU for a given circuit with the execution time on the CPU for that same given circuit. As one example, if circuit A took 2.0 seconds to execute on the CPU, but circuit A took 0.4 seconds to execute on the GPU, then the multiplication factor in this scenario would be 2.0/0.4=5. That multiplication/ratio factor would then be assigned to all the circuits belonging to the same group. That is, service 105 assigns each corresponding multiplication factor (Fᵢ) to each corresponding group (Gᵢ) associated with each circuit. The above operations constitute the training step(s) mentioned earlier.

The inference process is recited below and is illustrated in FIG. 1B, as shown by architecture 100B. Notably, architecture 100B may be an extension of architecture 100A of FIG. 1A.

As shown in FIG. 1B, service 105 interacts with an orchestration engine 155. Optionally, the orchestration engine 155 can be included as a part of the service 105. The orchestration engine 155 (O) probes various prediction models 160 to obtain estimates of execution times of quantum circuits on different computing hardware. That is, the prediction models 160 are designed to predict how long a circuit will take to execute on a given type of hardware (e.g., GPU hardware, CPU hardware, etc.).

Service 105 also interacts with a trained model 165 (M_{GPU}). Trained model 165 is structured to predict execution times of quantum circuits on the GPU.

Given a new circuit 170 (C) for which the orchestration engine 155 requires a prediction of execution time on the CPU, service 105 first obtains an estimate (t_{GPU}) of the execution on the GPU using the trained model 165, as shown by t_{GPU}=M_{GPU}(C). To be clear, instead of directly predicting the execution time on the CPU, the embodiments first predict the execution time of the circuit on the GPU.

Service 105 queries the set of stored multiplication factors 150 to find the multiplication factor (Fᵢ) for C by identifying to which group (Gᵢ) C would belong based on its characteristics (e.g., number of qubits). For instance, suppose the circuit included three qubits. The embodiments would conduct a query to find whatever group of circuits all had three qubits. The embodiments would then query to determine what the corresponding ratio/multiplication factor for that group was. Typically, the ratio factors are stored in a lookup table along with an indication as to which group each ratio factor is associated with.

Service 105 then obtains the estimate of the execution time on the CPU using the following equation: t_{CPU}=Fᵢ*t_{GPU}. This equation represents an estimate of the execution time of C on the CPU. That is, the embodiments apply the selected ratio factor to the GPU execution time to derive a prediction regarding the CPU execution time.

Service 105 returns t_{CPU} to the orchestration engine 155 so that the orchestration engine 155 can make one or more orchestration decisions based on the estimated times t_{CPU} and t_{GPU}. Optionally, one or more other workload constraints might be considered by the orchestration engine when determining which hardware (e.g., GPU or CPU) to use. These workload constraints may include bandwidth, processor usage, priority, and so on.

With the above steps, the value t_{CPU} becomes an upper bound of the execution time on the CPU because the multiplication factors were derived from the longest execution times on the GPU. That is, during the training phase, the circuits that took the longest to execute on the GPU were the circuits that were then executed using the CPU. The ratio factor was then determined for those circuits. Inasmuch as those circuits would be considered the worst performing circuits (in terms of execution times), an assumption can be made that their execution times would be the upper limit or upper bound in terms of execution time, so it is likely that the execution times for other, similar circuits would not exceed that worst-case scenario. By doing these estimations, the embodiments can reduce the amount of training data required to model execution times on the CPU because only a single circuit from each group is executed in order to obtain an upper bound.

In effect, the embodiments trade off some accuracy in the later prediction process to achieve an improved efficiency in the earlier training process. That being said, having an upper bound on the execution time is a highly beneficial piece of information for the orchestration engine 155 to consider when selecting whether to use the CPU or the GPU.

In this respect, the disclosed embodiments beneficially address the prediction of quantum circuit execution times on the CPU with minimal training data. As another benefit, the embodiments find upper-bound circuit execution times on the CPU from the execution of similar circuits on the GPU.

### Further Details

As mentioned previously, the disclosed embodiments address the challenges of collecting training data for the prediction of SLO metrics in the execution of quantum algorithms on quantum circuit simulation engines. Such predictions are beneficial in a workload orchestration setting, where an orchestration engine aims to place quantum computing jobs on the right piece of infrastructure to satisfy user or business constraints. Sometimes, even though the execution time might be longer on a CPU as compared to a GPU, the CPU may be selected due to other business constraints. Having those predicted estimation times, however, enables the orchestration engine to make a better decision as to which hardware is to be used.

One example of an orchestration instance is when a decision is to be made between running a quantum job on the CPU or on the GPU. Although it is expected that GPUs generally perform better than CPUs, past experience with modelling quantum workloads has shown that this is not always the case with relatively simple quantum algorithms (e.g., those that use a few qubits or use less than a threshold number of qubits). Therefore, if an SLO metric is not properly modelled, wrong predictions may lead to poor orchestration decisions and inadequate use of resources.

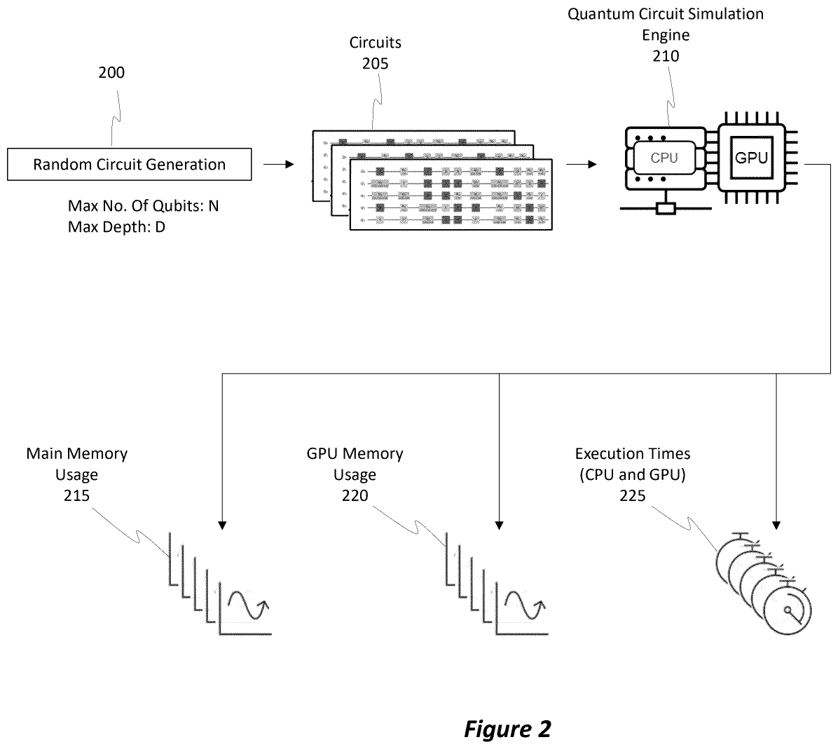

As described earlier, modelling starts with executing a large set (e.g., a number exceeding a predetermined threshold) of quantum jobs on simulation engines and collecting SLO metrics of interest, as illustrated in FIG. 2. The set of quantum jobs can be defined via a random quantum circuit generation procedure 200 that takes as input a range [N_min,N] for the number of qubits and a range [D_min,D] for the depth. Thousands of circuits 205 can be generated this way, and each one of them can be executed on the simulation engine 210 so that the embodiments can collect the desired metrics. If execution time is the SLO metric of interest, the embodiments run the circuits both on the GPU and on the CPU and collect the corresponding execution times. FIG. 2 shows various metrics, including main memory usage 215, GPU memory usage 220, and execution times 225.

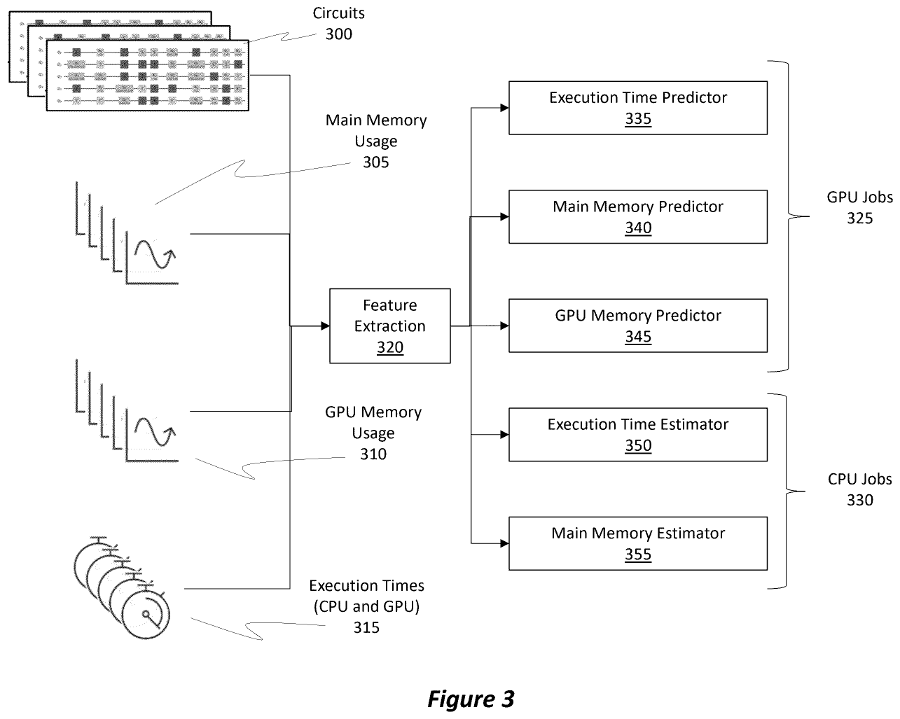

The set of collected metrics will form a training dataset from which the embodiments learn relationships y=f(X), where X are features of the quantum circuits extracted with some dedicated procedure and y is an SLO metric to predict (e.g., execution time). The training procedure will yield one model for each SLO metric and each target platform, as illustrated in FIG. 3.

Generally, FIG. 3 shows the circuits 300, the main memory usage 305, the GPU memory usage 310, and the execution times 315 (i.e. SLO metrics of potential interest) optionally being provided as input to a feature extraction 320 unit. That unit then makes various predictions or estimations related to GPU jobs 325 and CPU jobs 330. The GPU jobs 325 include an execution time predictor 335, a main memory predictor 340, and a GPU memory predictor 345. The CPU jobs 330 include an execution time estimator 350 and a main memory estimator 355.

A problem can potentially arise when the complexity of the circuits (especially the number of qubits) increases, and those circuits are run on the CPU. Because CPUs can be orders of magnitude slower than GPU in some cases, it may not be feasible to wait for the execution of all jobs to collect the training data for the CPU prediction models. The embodiments address this problem by proposing an estimator of CPU SLO metrics rather than a true predictor. This estimator can be built from a limited number of job executions on the CPU and by leveraging the training data collected for the entire set of jobs executed on the GPU.

### Training the Estimator

It should be recognized how the disclosed principles can be applied using any type of SLO metric. Recognizing the above and without loss of generality, a specific example involving execution time as the CPU SLO metric of interest will now be presented.

This example starts by executing a large collection of quantum circuits on a simulation engine that runs on the GPU, in much the same way as illustrated in FIG. 2. The embodiments can collect the description of the circuit, collect the execution times of the circuits (y), extract their features (X), and then store that data.

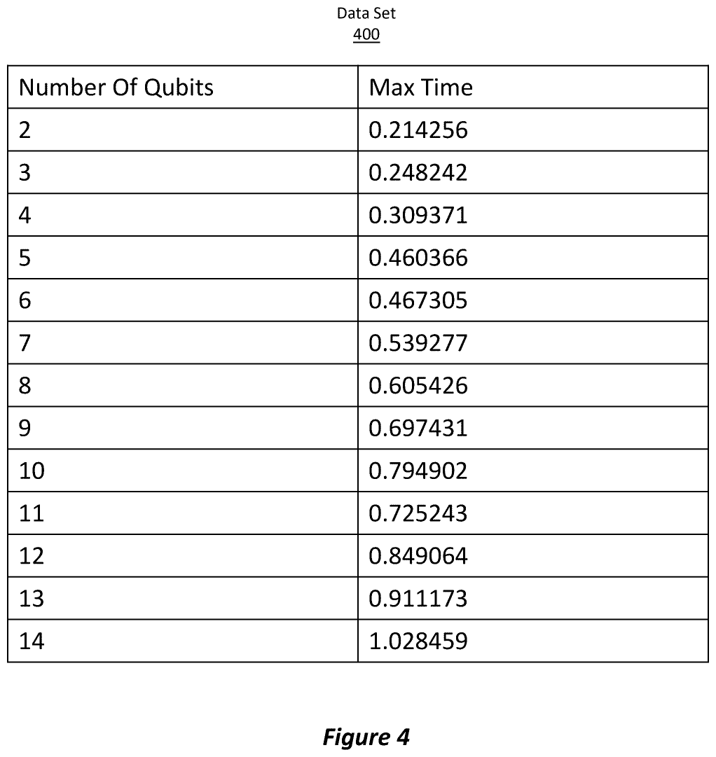

In the next step, the embodiments take the collected circuit execution data and group them by a given circuit characteristic, such as, perhaps, the number of qubits of the related quantum circuit. For each group of circuits having at least one common characteristic, the embodiments take the circuit (within each group) with the highest execution time when it was run using the GPU. The result is a data set (D), such as the data set 400 of FIG. 4. That is, data set 400 shows 13 groups of circuits, and data set 400 further shows the longest execution times for each circuit within its respective group.

In this example, the set of circuits provides an upper bound of GPU execution times for num_qubits∈[N_min, N]. Those times will be the baseline for the estimation of CPU execution times.

By construction, the embodiments know exactly which circuits correspond to the max GPU execution times obtained in the dataset above. The embodiments take each of those circuits and execute them on the CPU. For example, in the example shown in FIG. 4, a total of 13 circuits will be executed on the CPU. Note, originally there were potentially many thousands of random circuits that were executed on the GPU, but now there is only M=(1+N−N_min) to be executed on the CPU. The number that will be executed on the CPU is dependent on the number of groups that have been generated.

The embodiments execute those M circuits on the CPU and, as in the GPU case, the embodiments collect the execution time of each execution. The embodiments then associate the execution times with the entry of the dataset D corresponding to the circuit's number of qubits.

In some cases, multiple executions for the same circuit may be run on the CPU. The embodiments may then average these execution times to generate an average time. In other scenarios, each circuit is run only once on the CPU.

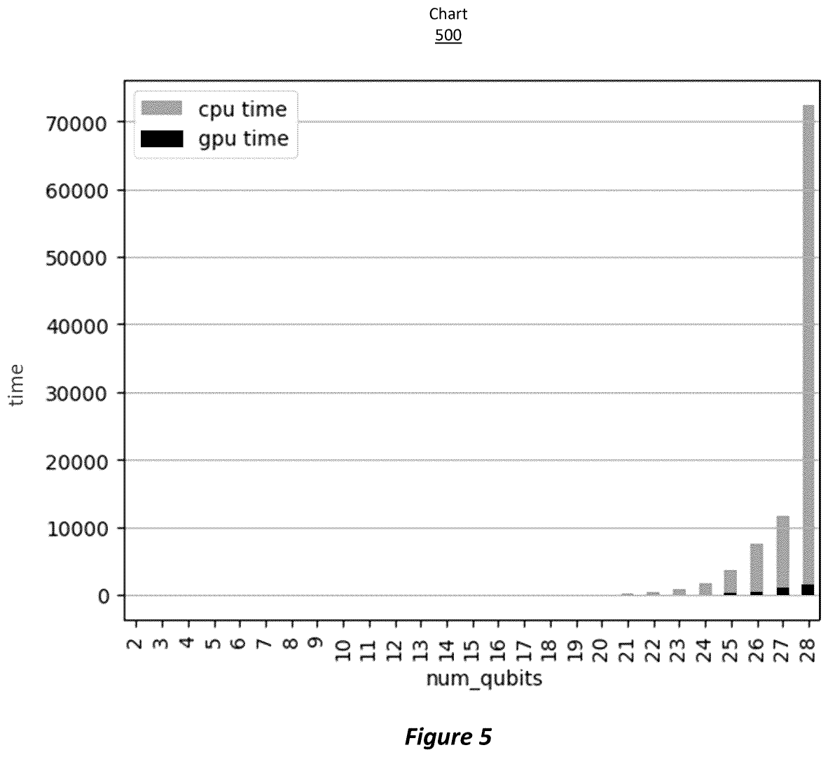

By plotting the relationships between GPU and CPU execution times, it is possible to obtain the chart 500 of FIG. 5. Note how, for circuits with less than 23 qubits, differences in execution times are barely noticeable. From an orchestration perspective, this means that, on average, even the slowest possible execution on the GPU will be very similar with the equivalent execution on the CPU. In other words, the orchestration engine can generally safely pick either a CPU-based or a GPU-based engine to run smaller circuits.

For larger circuits, however, the differences between CPU and GPU times grow significantly (e.g., perhaps even exponentially) with the number of qubits. The idea behind the CPU time estimator is to capture those differences across the entire data spectrum. The embodiments achieve this objective by computing a scaling factor (aka “multiplication factor” or “ratio factor”), Fᵢ=T_{CPU_i}/T_{GPU_I}, where i is the number of qubits of a circuit group in dataset D. In some implementations, the CPU time estimator can be included within a look-up table indexed by the number of qubits on a given circuit.

The estimator built in the training phase can now be used at inference time to help orchestration decisions. An assumption can be made that the orchestrator already has access to a trained model that is trained specifically to predict GPU execution times, referred to here as M_{g}.

When the orchestrator is about to orchestrate a new quantum job, represented by a quantum circuit (C) with n qubits, the orchestrator may first obtain a prediction of the GPU execution time, T_{GPU}=M_{g}(features(C)), by probing the trained model using the circuit's identified features. Then, the orchestrator can obtain T_{CPU}=Fₙ*T_{GPU} as an estimate of the CPU time for C by querying from dataset D the multiplication factor associated with n.

Since the CPU time estimator was built from an upper bound on the GPU execution times, the assumption is that the CPU time estimation represents a worst-case scenario for the execution of the job on the CPU. The orchestrator now has predictions for both GPU and CPU times, and it can use them to make the best decision about where to place the incoming quantum circuit according to the available infrastructure and user-defined constraints.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

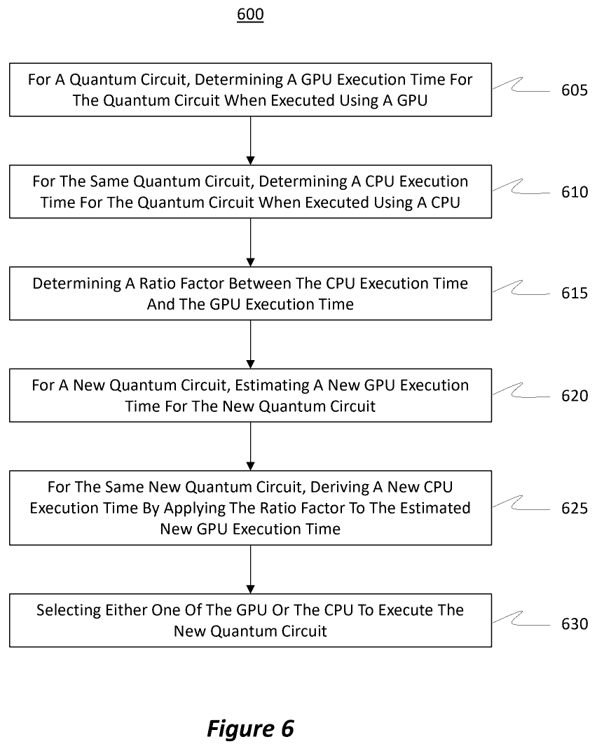

Attention will now be directed to FIG. 6, which illustrates a flowchart of an example method 600 for predicting and implementing the use of SLO metrics for the execution of quantum algorithms on quantum circuit simulation engines. Such predictions are beneficial in a workload orchestration setting, where an orchestration engine aims to place quantum computing jobs on the right piece of infrastructure to satisfy user or business constraints. Method 600 can be implemented within the architectures 100A and 100B of FIGS. 1A and 1B. Additionally, method 600 can be implemented by the service 105 of FIGS. 1A and 1B.

Method 600 includes an act (act 605) of determining, for a quantum circuit, a graphics processing unit (GPU) SLO metric (e.g., execution time) for the quantum circuit when that circuit is executed using a GPU. Optionally, the process of determining the GPU SLO metric (e.g., execution time) for the quantum circuit is performed by executing the quantum circuit using a simulation engine executing on the GPU.

In some cases, the circuit is one circuit among many, and the GPU execution time (or more broadly, the SLO metric) for that one circuit is one of multiple GPU execution times that were generated for all of the circuits using a simulation engine executing on the GPU. This particular GPU execution time may be an upper bound GPU execution time as a result of the GPU execution time being longest as compared to the other GPU execution times included in those multiple GPU execution times, particularly for ones included within a same defined group.

Stated differently, this original quantum circuit may be one among many (e.g., perhaps thousands or any number) quantum circuits. The embodiments are able to execute these circuits using the GPU and the simulation engine. The resulting execution times for all of these circuits are stored.

As mentioned earlier, the embodiments may also group the circuits based on a determined or selected characteristic, such as perhaps a qubit number. Once these circuits are grouped, the circuit having the longest execution time (within each group) is selected for execution using the CPU. Thus, this original quantum circuit is determined to be the one with the longest (or worst) execution time for its respective group (other circuits that were tested might have longer times, but those other circuits belong to different groups). Later, all of the circuits having the longest time periods for each group will be selected for execution using the CPU.

For the same quantum circuit, act 610 includes determining a central processing unit (CPU) SLO metric (e.g., execution time) for the quantum circuit when it is executed using a CPU. Optionally, the process of determining the CPU execution time for the quantum circuit is performed using the same simulation engine as before; this time the simulation engine is executing on the CPU.

Stated differently, the same simulation engine may execute the quantum circuit on the GPU and may execute the quantum circuit on the CPU. All of the selected circuits having the longest execution times can be executed using the CPU. Thus, one circuit from each defined group is selected for execution using the CPU.

Act 615 includes determining a ratio factor (aka scaling factor or multiplication factor) between the CPU SLO metric (e.g., execution time) and the GPU SLO metric (e.g., execution time). The ratio factor may be stored in a lookup table along with an indication of a selected characteristic that the quantum circuit is determined to have. For instance, the selected characteristic may be the number of qubits the circuit has. Stated differently, the selected characteristic may be the number of qubits that the quantum circuit has such that the ratio factor is stored in the lookup table along with an indication regarding the determined number of qubits.

In some implementations, the quantum circuit is one quantum circuit included in a defined group of quantum circuits. The defined group is defined based on a determination that all of the quantum circuits in the group share a same selected characteristic. The quantum circuit is selected from the group as a result of the GPU execution time for the quantum circuit being longest as compared to GPU execution times for other quantum circuits in the group. In some implementations, the same selected characteristic is a characteristic relating to a number of qubits that are associated with the quantum circuit.

Inasmuch as multiple circuits were executed using the CPU, multiple ratio factors (e.g., multiplication factors 150 from FIG. 1A) are generated. These ratio factors may be stored in the lookup table along with an indication as to which group each ratio factor belongs. If the groups are organized or defined based on qubit number, then the lookup table includes an indication that each ratio factor is associated with a specific qubit number.

Act 620 includes estimating, for a new quantum circuit, a new GPU SLO metric (e.g., execution time) for the new quantum circuit. The process of estimating the new GPU execution time for the new quantum circuit may be performed using a trained model that is trained to specifically predict GPU execution times. In some cases, the new quantum circuit is determined to have a same number of qubits as the original quantum circuit.

For the same new quantum circuit, act 625 includes deriving a new CPU SLO metric (e.g., execution time) by applying the ratio factor to the estimated new GPU execution time. Optionally, the ratio factor associated with the quantum circuit is selected to derive the new CPU execution time for the new quantum circuit based on a determination that the new quantum circuit and the original quantum circuit share a same selected characteristic. For instance, after determining the new quantum circuit's qubit number, the embodiments may query the lookup table to identify which ratio factor to use. That ratio factor may then be used for the derivation process.

Based at least on the estimated new GPU SLO metric (e.g., execution time) and the new CPU SLO metric (e.g., execution time), act 630 includes selecting either one of the GPU or the CPU to execute the new quantum circuit. In some cases, the estimated new GPU execution time is shorter than the new CPU execution time. Despite the new CPU execution time being longer than the estimated new GPU execution time, the CPU may, in some cases, be selected to execute the new quantum circuit. This scenario may occur (i.e. the CPU is selected) based on consideration of at least one additional parameter or workload constraint.

That is, in some cases, the selection of either the GPU or the CPU to execute the new quantum circuit is further based on a different workload constraint. For instance, the orchestration engine may be aware of other workload constraints (e.g., bandwidth, compute availability, resource utilization, delay times, priority levels, etc.), and those other workload constraints may result in the CPU being used. Although the actual execution time might take longer with the CPU, the overall time to completion might actually be shorter, due to other delays or availability with regard to the GPU. Thus, other workload constraints can influence the selection process.

### Example Computers/Computer Systems

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, client, engine, agent, services, and component are examples of terms that may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

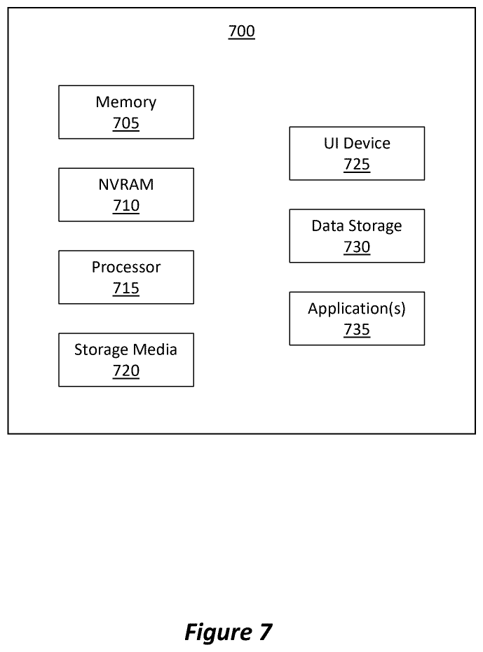

With reference briefly now to FIG. 7, any one or more of the entities disclosed, or implied, by the Figures and/or elsewhere herein, may take the form of, or include, or be implemented on, or hosted by, a physical computing device, one example of which is denoted at 700. Also, where any of the aforementioned elements comprise or consist of a virtual machine (VM), that VM may constitute a virtualization of any combination of the physical components disclosed in FIG. 7.

In the example of FIG. 7, the physical computing device 700 includes a memory 705 which may include one, some, or all, of random access memory (RAM), non-volatile memory (NVM) 710 such as NVRAM for example, read-only memory (ROM), and persistent memory, one or more hardware processors 715, non-transitory storage media 720, UI device 725, and data storage 730. One or more of the memory 705 of the physical computing device 700 may take the form of solid-state device (SSD) storage. Also, one or more applications 735 may be provided that comprise instructions executable by one or more hardware processors 715 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The physical device 700 may also be representative of an edge system, a cloud-based system, a datacenter or portion thereof, or other system or entity.

The disclosed embodiments can be implemented in numerous different ways, as described in the various different clauses recited below.

Clause 1. A method comprising: for a quantum circuit, determining a graphics processing unit (GPU) service-level-objective (SLO) metric for the quantum circuit when executed using a GPU; for the same quantum circuit, determining a central processing unit (CPU) SLO metric for the quantum circuit when executed using a CPU; determining a ratio factor between the CPU SLO metric and the GPU SLO metric; for a new quantum circuit, estimating a new GPU SLO metric for the new quantum circuit; for the same new quantum circuit, deriving a new CPU SLO metric by applying the ratio factor to the estimated new GPU SLO metric; and based at least on the estimated new GPU SLO metric and the new CPU SLO metric, selecting either one of the GPU or the CPU to execute the new quantum circuit.

Clause 2. The method of any of the preceding clauses, wherein the CPU SLO metric is a CPU execution time, wherein the GPU SLO metric is a GPU execution time, wherein the new CPU SLO metric is a new CPU execution time, and wherein the estimated new GPU SLO metric is a new GPU execution time.

Clause 3. The method of any of the preceding clauses, wherein determining the GPU execution time for the quantum circuit is performed by executing the quantum circuit using a simulation engine executing on the GPU, and wherein determining the CPU execution time for the quantum circuit is performed using the same simulation engine when the simulation engine is executing on the CPU.

Clause 4. The method of any of the preceding clauses, wherein the quantum circuit is one quantum circuit included in a defined group of quantum circuits, the defined group being defined based on a determination that all of the quantum circuits in the group share a same selected characteristic.

Clause 5. The method of any of the preceding clauses, wherein the quantum circuit is selected from the group as a result of the GPU execution time for the quantum circuit being longest as compared to GPU execution times for other quantum circuits in said group.

Clause 6. The method of any of the preceding clauses, wherein the ratio factor associated with the quantum circuit is selected to derive the new CPU execution time for the new quantum circuit based on a determination that the new quantum circuit and said quantum circuit share a same selected characteristic.

Clause 7. The method of any of the preceding clauses, wherein the estimated new GPU execution time is shorter than the new CPU execution time.

Clause 8. The method of any of the preceding clauses, wherein, despite the new CPU execution time being longer than the estimated new GPU execution time, the CPU is selected to execute the new quantum circuit, and the CPU is selected based on consideration of at least one additional parameter.

Clause 9. The method of any of the preceding clauses, wherein estimating the new GPU execution time for the new quantum circuit is performed using a trained model that predicts GPU execution times.

Clause 10. The method of any of the preceding clauses, wherein the GPU execution time is one of multiple GPU execution times that were generated using a simulation engine executing on the GPU, and wherein said GPU execution time is an upper bound GPU execution time as a result of said GPU execution time being longest as compared to other GPU execution times included in said multiple GPU execution times.

Clause 11. One or more hardware storage devices that store instructions that are executable by one or more processors of a computer system to cause the computer system to: for a quantum circuit, determine a graphics processing unit (GPU) execution time for the quantum circuit when executed using a GPU; for the same quantum circuit, determine a central processing unit (CPU) execution time for the quantum circuit when executed using a CPU; determine a ratio factor between the CPU execution time and the GPU execution time; for a new quantum circuit, estimate a new GPU execution time for the new quantum circuit; for the same new quantum circuit, derive a new CPU execution time by applying the ratio factor to the estimated new GPU execution time; and based at least on the estimated new GPU execution time and the new CPU execution time, select either one of the GPU or the CPU to execute the new quantum circuit.

Clause 12. The one or more hardware storage devices of any of the preceding clauses, wherein the quantum circuit is one quantum circuit included in a defined group of quantum circuits, the defined group being defined based on a determination that all of the quantum circuits in the group share a same selected characteristic.

Clause 13. The one or more hardware storage devices of any of the preceding clauses, wherein the same selected characteristic is a characteristic relating to a number of qubits that are associated with the quantum circuit.

Clause 14. The one or more hardware storage devices of any of the preceding clauses, wherein the ratio factor is stored in a lookup table along with an indication of a selected characteristic that the quantum circuit is determined to have.

Clause 15. The one or more hardware storage devices of any of the preceding clauses, wherein the selected characteristic is a number of qubits that the quantum circuit has such that the ratio factor is stored in the lookup table along with an indication regarding the determined number of qubits.

Clause 16. The one or more hardware storage devices of any of the preceding clauses, wherein the new quantum circuit is determined to have a same number of qubits as said quantum circuit.

Clause 17. The one or more hardware storage devices of any of the preceding clauses, wherein a same simulation engine executes the quantum circuit on the GPU and executes the quantum circuit on the CPU.

Clause 18. A computer system comprising: one or more processors; and one or more hardware storage devices that store instructions that are executable by the one or more processors to cause the computer system to: for a quantum circuit, determine a graphics processing unit (GPU) execution time for the quantum circuit when executed using a GPU; for the same quantum circuit, determine a central processing unit (CPU) execution time for the quantum circuit when executed using a CPU; determine a ratio factor between the CPU execution time and the GPU execution time; for a new quantum circuit, estimate a new GPU execution time for the new quantum circuit; for the same new quantum circuit, derive a new CPU execution time by applying the ratio factor to the estimated new GPU execution time; and based at least on the estimated new GPU execution time and the new CPU execution time, select either one of the GPU or the CPU to execute the new quantum circuit.

Clause 19. The computer system of any of the preceding clauses, wherein a lookup table stores the ratio factor.

Clause 20. The computer system of any of the preceding clauses, wherein selection of either the GPU or the CPU to execute the new quantum circuit is further based on a workload constraint.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
for a quantum circuit, determining a graphics processing unit (GPU) service-level-objective (SLO) metric for the quantum circuit when executed using a GPU;
for the same quantum circuit, determining a central processing unit (CPU) SLO metric for the quantum circuit when executed using a CPU;
determining a ratio factor between the CPU SLO metric and the GPU SLO metric;
for a new quantum circuit, estimating a new GPU SLO metric for the new quantum circuit;
for the same new quantum circuit, deriving a new CPU SLO metric by applying the ratio factor to the estimated new GPU SLO metric; and
based at least on the estimated new GPU SLO metric and the new CPU SLO metric, selecting either one of the GPU or the CPU to execute the new quantum circuit.

2. The method of claim 1, wherein the CPU SLO metric is a CPU execution time, wherein the GPU SLO metric is a GPU execution time, wherein the new CPU SLO metric is a new CPU execution time, and wherein the estimated new GPU SLO metric is a new GPU execution time.

3. The method of claim 2, wherein determining the GPU execution time for the quantum circuit is performed by executing the quantum circuit using a simulation engine executing on the GPU, and wherein determining the CPU execution time for the quantum circuit is performed using the same simulation engine now executing on the CPU.

4. The method of claim 2, wherein the quantum circuit is one quantum circuit included in a defined group of quantum circuits, the defined group being defined based on a determination that all of the quantum circuits in the group share a same selected characteristic.

5. The method of claim 4, wherein the quantum circuit is selected from the group as a result of the GPU execution time for the quantum circuit being longest as compared to GPU execution times for other quantum circuits in said group.

6. The method of claim 2, wherein the ratio factor associated with the quantum circuit is selected to derive the new CPU execution time for the new quantum circuit based on a determination that the new quantum circuit and said quantum circuit share a same selected characteristic.

7. The method of claim 2, wherein the estimated new GPU execution time is shorter than the new CPU execution time.

8. The method of claim 2, wherein, despite the new CPU execution time being longer than the estimated new GPU execution time, the CPU is selected to execute the new quantum circuit, and the CPU is selected based on consideration of at least one additional parameter.

9. The method of claim 2, wherein estimating the new GPU execution time for the new quantum circuit is performed using a trained model that is trained to predict GPU execution times.

10. The method of claim 2, wherein the GPU execution time is one of multiple GPU execution times that were generated using a simulation engine executing on the GPU, and
wherein said GPU execution time is an upper bound GPU execution time as a result of said GPU execution time being longest as compared to other GPU execution times included in said multiple GPU execution times.

11. One or more hardware storage devices that store instructions that are executable by one or more processors of a computer system to cause the computer system to:
for a quantum circuit, determine a graphics processing unit (GPU) execution time for the quantum circuit when executed using a GPU;
for the same quantum circuit, determine a central processing unit (CPU) execution time for the quantum circuit when executed using a CPU;
determine a ratio factor between the CPU execution time and the GPU execution time;
for a new quantum circuit, estimate a new GPU execution time for the new quantum circuit;
for the same new quantum circuit, derive a new CPU execution time by applying the ratio factor to the estimated new GPU execution time; and
based at least on the estimated new GPU execution time and the new CPU execution time, select either one of the GPU or the CPU to execute the new quantum circuit.

12. The one or more hardware storage devices of claim 11, wherein the quantum circuit is one quantum circuit included in a defined group of quantum circuits, the defined group being defined based on a determination that all of the quantum circuits in the group share a same selected characteristic.

13. The one or more hardware storage devices of claim 12, wherein the same selected characteristic is a characteristic relating to a number of qubits that are associated with the quantum circuit.

14. The one or more hardware storage devices of claim 11, wherein the ratio factor is stored in a lookup table along with an indication of a selected characteristic that the quantum circuit is determined to have.

15. The one or more hardware storage devices of claim 14, wherein the selected characteristic is a number of qubits that the quantum circuit has such that the ratio factor is stored in the lookup table along with an indication regarding the determined number of qubits.

16. The one or more hardware storage devices of claim 11, wherein the new quantum circuit is determined to have a same number of qubits as said quantum circuit.

17. The one or more hardware storage devices of claim 11, wherein a same simulation engine executes the quantum circuit on the GPU and executes the quantum circuit on the CPU.

18. A computer system comprising:
one or more processors; and
one or more hardware storage devices that store instructions that are executable by the one or more processors to cause the computer system to:
for a quantum circuit, determine a graphics processing unit (GPU) execution time for the quantum circuit when executed using a GPU;
for the same quantum circuit, determine a central processing unit (CPU) execution time for the quantum circuit when executed using a CPU;
determine a ratio factor between the CPU execution time and the GPU execution time;
for a new quantum circuit, estimate a new GPU execution time for the new quantum circuit;
for the same new quantum circuit, derive a new CPU execution time by applying the ratio factor to the estimated new GPU execution time; and
based at least on the estimated new GPU execution time and the new CPU execution time, select either one of the GPU or the CPU to execute the new quantum circuit.

19. The computer system of claim 18, wherein a lookup table stores the ratio factor.

20. The computer system of claim 18, wherein selection of either the GPU or the CPU to execute the new quantum circuit is further based on a workload constraint.
